(19) United States
(12) Patent Application Publication
(10) Pub. No.: US 2015/0264956 A1
(43) Pub. Date: Sep. 24, 2015

(54) PROCESS FOR PRODUCTION OF COCOA BUTTER EQUIVALENT

(71) Applicant: Rasmus Leth Miller, Viby J (DK)

(72) Inventor: Rasmus Leth Miller, Viby J (DK)

(73) Assignee: AARHUSHARLSHAMN AB, Malmo (SE)

(21) Appl. No.: 14/426,701

(22) PCT Filed: Sep. 7, 2012
(86) PCT No.: PCT/DK2012/050337

§ 371 Date: Mar. 6, 2015

(51) Int. Cl. A23G 1/38; A23D 9/04

(52) U.S. Cl. CPC A23G 1/38; A23D 9/04; A23V 2002/00

(57) ABSTRACT

The invention relates to a process for production of cocoa butter equivalent (CBEO), the process comprising the steps of:
providing shea fat (SF);
separating the shea fat into a first shea stearin fraction (FSS) and a shea intermediate product (SIP);
feeding the first shea stearin fraction (FSS) into a first processing line (FPL),
feeding the shea intermediate product (SIP) into a second processing line (SPL);
processing the shea intermediate product (SIP) in the second production line (SPL) into a second shea stearin fraction (SSS);
obtaining two separate shea stearin outputs, the first shea stearin fraction (FSS) from the first processing line (FPL) and the second shea stearin fraction (SSS) from the second processing line (SPL); and
   mixing the shea stearin outputs (FSS, SSS) with a palm oil mid fraction (MIX; MIX1, MIX2) to obtain cocoa butter equivalent (CBEO; CBEO1, CBEO2).

### FIELD OF THE INVENTION

The invention relates to a process according to claim 1.

### BACKGROUND OF THE INVENTION

For many years, it has been known to produce cocoa butter equivalent on the basis of shea nuts. A problem in relation to the utilization of shea nuts is that shea nuts are relatively expensive and that the effective utilization until now is relatively low.

### SUMMARY OF THE INVENTION

The invention relates to a process for production of cocoa butter equivalent (CBE), the process comprising the steps of
providing shea fat
   separating the shea fat into a first shea stearin fraction and a shea intermediate product,
   feeding the first shea stearin fraction into a first processing line,
   feeding the shea intermediate product into a second processing line,
   processing the shea intermediate product in the second production line into a second shea stearin fraction,
   obtaining two separate shea stearin outputs, the first shea stearin fraction from the first processing line and the second shea stearin fraction from the second processing line and
   mixing the shea stearin outputs with a palm oil mid fraction to obtain cocoa butter equivalent.

An advantage of the above processing is that the obtained cocoa butter equivalent may be adjusted from the properties of the natural content of the shea stearin contained in the shea nuts to the properties of the shea stearin produced on the basis of the shea intermediate product extracted or derived from the same shea nut source.

This is in particular an advantage if the second shea stearin fraction is obtained by a very selective and precise production method, such as an enzymatic transesterification. In that case, it will be possible to obtain a natural output of shea stearin from the first processing line and a pure shea stearin from the second processing line. These two types of shea stearin may thereafter be dealt with separately or together depending on the requirements to the final CBE of shea stearin mixture. In other words, it will be possible to finalize the stearin outputs of the two processing lines individually e.g. by the mixing of different amounts of palm oil mid fraction (PMF) into the two different shea stearin types. It may also be possible to mix the same amount of PMF into the two stearin types, thereby maintaining the advantages of the two stearin types. In this context it is noted that the first stearin fraction will have a natural variation in the triglyceride composition e.g. depending on the geographical origin of the shea nuts and which year the shea nuts have been harvested.

Note that a PMF may be understood as different palm oil products. Preferably, the PMF should be understood as a hard PMF having an iodine value of 30 to 35, such as 32, 33, or 34. However, in some embodiments, a softer PMF having a higher iodine value of up to e.g. 50 may be usable.

This variation may be less significant or absent in the second shea stearin fraction due to the fact that the second shea stearin fraction is obtained on the basis of an intermediate product from a shea source. The variation in triglyceride composition of the second shea stearin fraction may be very little in case the second shea stearin fraction may be produced through a very selective process, such as by means of e.g. an enzymatic transesterification.

The shea stearin of the first processing line may e.g. be produced by a fractioning process, meaning that the stearin fraction of the first production line is shea stearin originating from and contained in the shea nut.

It is therefore possible to obtain a final CBE mixture on the basis of any mixture of the first shea stearin fraction and the second shea stearin fraction, the mixture including the application of only one of the two processing lines, either the first shea fraction alone or the second shea fraction alone or any combinations thereof.

One of several advantages of the invention is that the second shea stearin fraction obtained from shea nut input adds further shea stearin to the shea stearin outputs than originally contained in the shea nut input due to the fact that some of the non-stearin content of the shea nut is further processed into stearin content in a separate processing line.

The process may therefore be regarded as a very high-gain process and a high utilization of the shea nut input.

According to an embodiment of the invention, a shea stearin is to be understood as a higher melting point fraction or part of shea fat. It may also be understood as a fraction or part, which is rich in StOSt triglycerides (where St=stearic acid and O=oleic acid).

According to an embodiment of the invention, the shea stearin output comprising the first shea stearin fraction and the second shea stearin fraction is individually mixed with palm oil mid fraction to obtain two separate cocoa butter equivalent outputs.

According to an advantageous embodiment of the invention, the two separate CBE lines may be handled individually during or prior to the producing of the individual CBE line. This means e.g. that the mixing of the PMF with the provided shea stearin may be adapted to fit the shea stearin of the individual line. This is very beneficial for many reasons due to the fact that the shea stearin naturally contained in the shea nut input and separated into the corresponding processing line will have a different compositions and mix of triglycerides than the shea stearin provided on the basis of the intermediate product of the other processing line.

In fact, experiments have shown that this different content of triglycerides will result in different properties of chocolate produced on the basis of the produced CBE. According to the provisions of the above embodiment it is therefore possible to make an individual mixture of the two processing lines and either adjust the two outputs individually to obtain the desired properties of each line or mix the stearin outputs into a single output line with the PMF to obtain one common property of the CBE output.

Moreover, it will be possible to maintain the two outputs and thereby take advantage of the different properties of the two processing lines.

According to an embodiment of the invention, the outputs of the two processing lines are individually mixed with palm oil mid fraction.

According to a further embodiment of the invention, the outputs of the two processing lines are mixed with palm oil mid fraction in a common mixing process.

According to an embodiment of the invention, the common mixing may be performed by an initially mixing of the shea stearin obtained in both processing lines and a subsequent mixing with PMF.

Evidently, the same effect may be obtained by performing the mixing with PMF in both processing lines to obtain separate cocoa butter equivalents and then, subsequently, mixing the cocoa butter equivalents to obtain a common cocoa butter equivalent.

According to an embodiment of the invention, the process comprises the steps of:

a) separating the shea fat into a first shea stearin fraction rich in 1,3-distearyl-2-oleyl triglycerides (StOSt, where St=stearic acid and O=oleic acid) and a first shea olein fraction rich in 1-stearyl-2,3-dioleyl triglycerides (StOO) and/or trioleate triglycerides (OOO),
b) feeding a shea olein fraction comprising the first shea olein fraction, together with a stearic acid source, into a reaction system comprising immobilized enzymes having transesterification activity to produce a transesterification product,
c) separation from the transesterification product a second shea stearin fraction rich in StOSt, thereby producing a shea stearin output comprising the first shea stearin fraction in a first processing line and the second shea stearin fraction in a second processing line.

According to the provisions of the invention it will be possible to utilize shea fat as a direct source of CBE component and at the same time as a source of a CBE intermediate product. The intermediate product may thereafter be processed into a further source of CBE.

By using the process according to the above described embodiment of the invention, a shea stearin output is obtained, which contains both the first shea stearin fraction obtained from the shea fat by fractionation, and the second shea stearin fraction obtained by transesterification of an olein fraction. Thereby, not only the first shea stearin fraction, but also the first shea olein fraction has potential as a valuable fraction from the shea fat. More specifically, by feeding the shea fat through the process of the invention, the yield of StOSt from the shea fat is maximized and extended beyond the potential limited by the initial StOSt content in shea fat. Therefore, the value of the shea fat is increased by the process of the invention.

According to an embodiment of the invention, fractionation is to be understood as a crystallization fractionation comprising at least the steps of crystallizing a part of an input, then separating the crystallized part from the liquid to obtain at least two outputs.

According to an embodiment of the invention, the first shea olein fraction is to be understood as being the shea intermediate product.

According to another embodiment of the invention, said first shea stearin fraction comprises between 30 and 100 percent by weight of StOSt, such as between 40 and 90 percent by weight of StOSt, such as between 50 and 80 percent by weight of StOSt, such as between 60 and 70 percent by weight of StOSt, such as between 62 and 68 percent by weight of StOSt, such as between 63 and 67 percent by weight of StOSt.

Shea nuts are natural products and may vary in fat content and in the exact chemical composition of the fat. According to embodiments of the present invention obtaining the first shea stearin fraction generates a minimum output of StOSt, despite the natural variations.

According to another embodiment of the invention, said first shea olein fraction comprises between 30 and 70 percent by weight of StOO, such as between 40 and 60 percent by weight of StOO, such as between 45 and 55 percent by weight of StOO, such as between 45 and 50 percent by weight of StOO, such as 46, 47, 48, or 49 percent by weight of StOO.

Shea nuts are natural products and may vary in fat content and in the exact chemical composition of the fat. According to embodiments of the present invention obtaining the first shea olein fraction generates a minimum output of StOO, despite the natural variations. In one example the first shea olein fraction comprises 48.5 percent by weight of StOO.

According to an embodiment of the invention, said first shea olein fraction comprises between 1 and 20 percent by weight of OOO, such as between 5 and 15 percent by weight of OOO, such as between 8 and 12 percent by weight of OOO, such as 9, 10, or 11 percent by weight of OOO.

Shea nuts are natural products and may vary in fat content and in the exact chemical composition of the fat. According to embodiments of the present invention obtaining the first shea olein fraction generates a minimum output of OOO, despite the natural variations. In one example the first shea olein fraction comprises 10.2 percent by weight of OOO.

Furthermore, according to an embodiment, the shea fat may also comprise other triglycerides than those mentioned above, such as e.g. StOLi (Li=linoleic acid). In an example, the shea fat may comprise e.g. around 5 percent by weight of StOLi. The StOLi having linoleic acid in position 3 may be transesterified by the transesterification enzyme to give StOSt. The linoleic acid, which is separated from the triglyceride in such a reaction, may be in the form of a free fatty acid, or as an alkyl ester, depending on the stearic acid source used in the transesterification process. The separated linoleic acid may be hydrogenated similar to oleic acid to give stearic acid.

According to an embodiment of the invention, the temperature in the reaction system is between 45 and 75° C., such as between 45 and 70° C., such as between 50 and 70° C., such as between 60 and 70° C.

By controlling the temperature to be below a maximum temperature as specified above, an advantage of extending the enzyme lifetime is achieved. This is because the enzymes may degrade faster when a maximum temperature is exceeded. Furthermore, by operating above a temperature minimum as specified above, a further advantage of avoiding crystallization of the fat is achieved. This is because the fat may crystallize when the temperature drops below a temperature minimum. Preferably, the temperature is between 50° C. and 70° C., and even more preferable between 60° C. and 70° C. In example embodiments, the temperature may be e.g. 50° C., 56° C., 58° C., 60° C., 62° C., 64° C., 66° C., 68° C., 72° C., or other temperatures within the given interval.

According to an embodiment of the invention, the water content of the first shea olein fraction is between 0.01 and 0.5 percent by weight when it is fed into the reaction system, such as between 0.01 and 0.3 percent by weight, such as between 0.01 and 0.1 percent by weight, such as between 0.015 and 0.03 percent by weight.

The water content is preferably around 0.02 percent by weight. By having the water content of the first shea olein fraction as described above, at least two distinct advantages are achieved. First, by reducing the water content the formation of diglycerides, such as distearate diglycerides may be reduced. Secondly, by having the water content above a threshold, the lifetime of the enzymes may be extended. This is because enzymes may degrade if the water content is too low. However, in some embodiments the water content may be higher than 0.02 percent by weight, such as e.g. 0.1 or 0.2 percent by weight. This may e.g. be due to surface active substances and/or particles in the shea fat, such as e.g. hygroscopic substances and/or particles, which makes the water content higher.

An advantage of the above embodiment is that, the lifetime of enzymes is extended. This is because the enzymes are inactivated if the water content is too low. A further advantage is that the concentration of diglycerides is kept sufficiently low, as too much water results in more diglycerides. These two advantages may be obtained at the same time by means of the above embodiment.

According to an embodiment of the invention, the stearic acid source is stearic acid.

An advantage of the above embodiment is that stearic acid may be allowable in food and foodstuff products. Therefore, it may not be necessary to remove the stearic acid source, such as stearic acid and/or esters thereof and any other free fatty acids, such as oleic acid and/or esters thereof, from the second shea stearin fraction.

According to an embodiment of the invention, the stearic acid source is an ester of stearic acid.

An advantage of the above embodiment is that esters of stearic acid have a low melting and/or a low boiling point, e.g. when compared to stearic acid. Thereby, processing equipment may be cheaper. Furthermore, by using esters of stearic acid instead of stearic acid itself, an advantage may be achieved, as the transesterification process may be carried out with lower water content. Since the presence of water in the transesterification process is undesirable because it results in formation of disadvantageous diglycerides, it may therefore be an advantage to use esters of stearic acid while lowering the water content and therefore the subsequent diglycerides formation.

According to an embodiment of the invention, said ester of stearic acid is a lower alkyl ester.

Lower alkyl esters may be preferred over esters of longer alkyls. According to example embodiments, lower alkyl esters of stearic acid, such as e.g. methyl, ethyl or propyl esters of steric acid may be used.

According to an embodiment of the invention, said lower alkyl ester is a methyl ester. I.e. according to this embodiment the lower alkyl ester is methyl stearate.

According to an embodiment of the invention, the transesterification product is separated into at least a second shea olein fraction and the second shea stearin fraction by a fractionation process.

An advantage of the above embodiment is that fractionation may provide with an effective solution for separating the transesterification product into a stearin fraction having a high content of StOSt triglycerides and an olein fraction having a low content of StOSt triglycerides.

According to an embodiment of the invention, said fractionation is a solvent fractionation comprising the steps of
adding a solvent to the transesterification product,
adjusting the temperature according to a temperature profile,
separating from the transesterification product the second shea stearin fraction and the second shea olein fraction.

The above described fractionation process may also be known as fractional crystallization. Adjusting the temperature according to a temperature profile may e.g. be lowering the temperature by a constant cooling rate. This cooling may be interrupted once or several times during the cooling by a time interval of constant temperature. Also, the cooling rate may change for each cooling interval or may change continuously. The solvent may be removed from the second shea stearin fraction and/or the second shea olein fraction after the fractionation.

According to an embodiment of the invention, the solvent comprises hexane.

An alternative solvent may be e.g. acetone, or other suitable solvents for fat, or mixtures thereof. As an alternative to solvent fractionation, dry fractionation may be used.

According to an embodiment of the invention, the temperature profile comprises temperatures between −15 and 5° C., such as between −12 and 0° C., preferably between −10 and −2° C.

Examples of temperatures in relation to the above embodiment may be e.g. −12° C., −10° C., −8° C., −6° C., −4° C., −2° C., 0° C., 2° C., or 4° C. An advantage of the above described embodiment may be that the separation efficiency may be increased.

According to an embodiment of the invention, the end point temperature of the temperature profile is between −15 and 5° C., preferably between −10 and −2° C.

By end point temperature is meant the last temperature of the temperature profile. The temperature profile may comprise one or more time intervals with constant temperature, such a constant temperature interval may also terminate the temperature profile. Examples of temperatures in relation to the above embodiment may be e.g. −12° C., −10° C., −8° C., −6° C., −4° C., −2° C., 0° C., 2° C., or 4° C. For acetone the temperature may e.g. be 0 to 20° C., preferably as 5 to 15° C. An advantage of the above described embodiment may be that the separation efficiency may be increased.

According to an embodiment of the invention, the second shea olein fraction is recycled into the step of feeding the shea olein fraction, together with the stearic acid source, into the reaction system comprising immobilized enzymes having transesterification activity to produce the transesterification product.

An advantage of the above embodiment is that by recycling the second shea olein fraction back into the transesterification step, a higher degree of conversion of StOO and/or OOO into StOSt may be obtained, and, thereby, a higher yield of StOSt from the shea fat may be obtained. By recycling the second olein fraction into the transesterification process a high yield may be obtained even for a moderate conversion efficiency of the transesterification enzymes, since an unconverted or at least not fully converted part of the second olein fraction may be converted by subsequently passing through the transesterification reaction system.

According to an embodiment of the invention, a fatty acid ester mixture, comprising esters of stearic and/or oleic acid, are being separated from the transesterification product, this separated fatty acid ester mixture being subjected to a hydrogenation step so as to increase the relative content of esters of stearic acid, and the hydrogenated esters are recycled into the step of feeding the shea olein fraction, together with the stearic acid source into a reaction system comprising immobilized enzymes having transesterification activity to produce the transesterification product.

An advantage of the above embodiment is that by hydrogenating the esters of the fatty acids, primarily esters of oleic acid, but also esters of e.g. linoleic acid or other fatty acids comprising two or more double bonds, these esters are converted into esters of stearic acid, which may be recycled into the transesterification step. Thereby, the need for external supply stearic esters may be minimized. The esters of stearic acid may be esters mixed with the first shea olein fraction and which have been fed into the transesterification process, but which have not reacted with any oleic acid of the triglycerides, i.e. it may e.g. be unreacted esters of stearic acid or esters, which have reacted with stearic acid of the triglycerides. The esters of oleic acid, linoleic acid, or other unsaturated fatty acids may be esters, which have been formed during the transesterification process by reaction between an oleic acid of a triglyceride and an ester of stearic acid.

According to an embodiment of the invention, said separation of esters of stearic and/or oleic acid from the transesterification product comprises a distillation to separate a fatty acid esters mixture comprising esters of stearic and/or oleic acid from the transesterification product.

An advantage of the above embodiment of using distillation to separate fatty acid esters from the transesterification product is that an effective separation may be obtained using distillation.

According to an embodiment of the invention, said hydrogenation step comprises use of a nickel catalyst.

An advantage of using a nickel catalyst according to the above embodiment is that it provides an effective method for converting fatty acid ester into ester of stearic acid by reducing double bonds to single bonds by hydrogenation. Furthermore, by using a nickel catalyst, the temperature of hydrogenation may be significantly lowered.

According to an embodiment of the invention, a purge stream is separated from the second shea olein fraction.

An advantage of the above embodiment is that by separating a stream from the second shea olein fraction, it is prevented that the concentration of certain chemical compounds and/or impurities, such as unwanted chemical compounds, builds up. Furthermore, by adjusting the fraction of the second shea olein fraction that is separated away as a purge stream, an upper limit of the concentration of such chemical compounds may be adjusted. By increasing the purge stream, such upper limits are reduced.

According to an embodiment of the invention, said purge stream comprises unsaponifiables.

An advantage of the above embodiment is that the unsaponifiables may be valuable, and that the purge stream and/or a part of the purge stream comprising unsaponifiables may be used in other products.

According to an embodiment of the invention, the purge stream comprises triterpenyl esters.

An advantage of the above embodiment is that the triterpenyl esters may be valuable, and that the purge stream and/or a part of the purge stream comprising triterpenyl esters may be used in other products.

According to an embodiment of the invention, between 40 and 100 percent by weight of the total content of triglycerides in the shea stearin output are StOSt, such as between 50 and 100 percent by weight, such as between 60 and 100 percent by weight, such as between 60 and 80 percent by weight, such as between 60 and 70 percent by weight, preferably between 63 and 67 percent by weight, such as 66 percent by weight.

An advantage of the above embodiment is that the shea stearin output may be used to produce CBE. The content of StOSt in the StOSt component used to make CBE is according to an example embodiment preferably around 66 percent by weight. If the content of StOSt in the shea stearin output is substantially higher than the preferred content, a low StOSt content fraction, such as an olein fraction, may be added to reduce the relative content of StOSt. As low StOSt content fractions are relatively cheap compared to high StOSt content fractions, this will not increase the cost significantly.

According to an embodiment of the invention, the content of StOSt relative to the total content of triglycerides in the shea stearin output is increased by 5 to 100 percent by weight compared to the provided shea fat (SF) by means of the process of the invention, such as between 15 and 100 percent by weight, such as between 15 and 50 percent by weight, such as between 15 and 30 percent by weight, such as between 15 and 25 percent by weight, such as 16, 17, 18, 19, 20, 21, 22, 23, or 24 percent by weight.

An advantage of the above embodiment is that by increasing the yield of StOSt from the shea fat, the value of the shea fat increases. In an example embodiment, from 1 kg of shea fat containing approximately 36% by weight of StOSt an output of the process according to the above embodiment may result in a content of StOSt of approximately 56% by weight. Thereby an increase in the StOSt content from 36 to 56% by weight is achieved, i.e. an increase of approximately 20% by weight in the content of StOSt.

According to an embodiment of the invention, the ratio between the stearic acid and oleic acid in the shea stearin output is between 2:3 and 2:1.

An advantage of the above embodiment is that the shea stearin output is usable as e.g. a StOSt component in a CBE.

According to an embodiment of the invention, the ratio between the stearic acid and oleic acid in the shea stearin output is between 6:5 and 2:1.

An advantage of the above embodiment is that the shea stearin output is usable as e.g. a StOSt component in a CBE.

According to an embodiment of the invention, the yield of StOSt in the shea stearin output is between 20 and 100 percent by weight higher than the content of StOSt in the shea fat, such as between 30 and 100 percent by weight, such as between 40 and 80 percent by weight, such as between 50 and 70 percent by weight, such as 55, 60, or 65 percent by weight.

An advantage of the above embodiment is that by increasing the yield of StOSt from the shea fat, the value of the shea fat increases.

According to an embodiment of the invention, the content of StOSt in the shea stearin output is between 50 and 80 percent by weight, such as between 60 and 70 percent by weight, such as between 63 and 67 percent by weight.

An advantage of the above embodiment is that the shea stearin output is usable as e.g. a StOSt component in a CBE.

According to an embodiment of the invention, the amount of StOSt in the shea stearin output is between 101 and 200% of the amount of StOSt in the portion of shea fat used to produce said shea stearin output, such as between 120 and 190%, such as between 140 and 180%, such as between 150 and 170%.

An advantage of the above embodiment is that by increasing the yield of StOSt from the shea fat, the value of the shea fat increases.

According to an embodiment of the invention, the method comprises a subsequent step of mixing the shea stearin output with a palm oil mid fraction to obtain a cocoa butter equivalent.

By obtaining a CBE from the shea stearin output, the value of the shea stearin is increased. By using the shea stearin output, the potential for CBE production using shea fat is increased, since both the first shea stearin fraction and the second shea stearin fraction may be used to produce CBE.

According to an embodiment of the invention, the cocoa butter equivalent comprises the shea stearin output or a part thereof in the amount of between 40% and 50% by weight.

An advantage of the above embodiment is that a CBE with an advantageous melting point may be obtained. In an example, 46% by weight of the CBE is the shea stearin output or a part thereof.

According to an embodiment of the invention, the enzymes comprise 1,3-specific enzymes.

An advantage of the above embodiment is that by selectively replacing the fatty acids on position 1 and/or 3 of the triglycerides, such as StOO and OOO, a high yield of StOSt may be obtained. Furthermore, StOO and OOO have O in position 2, these needs only to have the fatty acids on position 1 and/or 3 replaced with stearic acid and may therefore be suitable for transesterification with 1,3-specific enzymes to obtain StOSt.

According to an embodiment of the invention, the 1,3-specific enzymes comprise lipases.

Examples of such 1,3-specific lipases may e.g. be lipases of Rhizopus delemar, Mucor miehei, Aspergillus niger, Rhizopus arrhizus, Rhizopus niveus, Mucor javanicus, Rhizopus javanicus, Rhizopus oxyzae, and Rhicomucor miezei. Other 1,3-specific lipases may also be used.

According to an embodiment of the invention, the process for efficient utilization of shea fat comprises a step of removing karitene from the shea fat before the step of separating the shea fat into the first shea stearin fraction the first shea olein fraction.

An advantage of the above embodiment is obtained by removing karitene. Since karitene give rise to problems associated with oxidation, such problems are avoided or at least significantly reduced by the above embodiment. This is especially an advantage for confectionary products comprising the shea stearin output or a part thereof, since karitene has a negative impact on the taste.

According to an embodiment of the invention, the concentration of karitene in the shea fat after the step of removing karitene is less than 0.6 percent by weight, such as less than 0.5 percent by weight, such as less than 0.4 percent by weight, such as less than 0.3 percent by weight, such as less than 0.2 percent by weight, such as less than 0.1 percent by weight.

An advantage of the above embodiment is that the concentration of karitene is sufficiently low to avoid typical problems associated with karitene, such as taste corruption due to oxidation, problems with filtering of the shea fat, viscosity corruption of products of the shea fat etc.

According to an embodiment of the invention, the karitene is completely removed from the shea fat.

By completely removed may e.g. be meant that the content karitene is reduced until trace amounts, or that the karitene content is reduced to below the detection limit.

According to an embodiment of the invention, the shea fat is obtained from the shea nuts by pressing and/or extraction.

The extraction of shea fat from shea nuts may comprise a step of adding a solvent, such as e.g. hexane or other suitable solvents.

According to an embodiment of the invention, the second shea stearin fraction is subjected to a bleaching step.

According to an embodiment of the invention, the second shea olein fraction is subjected to a bleaching step.

According to an embodiment of the invention, the cocoa butter equivalent is subjected to a bleaching step.

The invention furthermore relates to a process for making cocoa butter equivalent from the shea stearin output obtained according to any of the preceding claims and a palm oil mid fraction,

wherein between 1.2 and 2 kilograms of cocoa butter equivalent is produced for each kilogram of the shea fat, such as between 1.4 and 1.8 kilograms, such as between 1.5 and 1.7 kilograms, such as 1.6 kilograms.

By producing a CBE from the shea stearin output, which comprises both the first shea stearin fraction and the second shea stearin fraction, the applicability of the shea fat for making CBE is increased. In other words, according to the above embodiment the CBE applicability of the shea fat is increased. For example, one kilogram of shea fat may, together with a PMF, produce a maximum of 1.1 kilogram of CBE. However, by means of the process according to the above embodiment, one kilogram of shea fat may be used to produce 1.2 kg, 1.3 kg, 1.4 kg, 1.5 kg, 1.6 kg, 1.7 kg, 1.8 kg, 1.9 kg, or 2 kg of CBE.

According to an embodiment of the invention, a stearin fraction having a high content of StOSt is mixed with a palm oil mid fraction to give cocoa butter equivalent.

According to an embodiment of the invention, an olein fraction having a high content of StOO and/or OOO is subjected to an enzymatic transesterification process (ETE), thereby increasing the relative content of StOSt to give an enriched olein fraction. Methyl stearate (MeSt) is added to the process as a source for stearic acid (St). After the ETE process the enriched olein fraction is distilled to separate the fatty acid methyl esters (FAME), such as MeSt and methyl oleate MeO, from the glycerides. The FAME is hydrogenated, such that all FAME is MeSt, or at least the relative content of MeSt is increased. This MeSt is fed back into the ETE process again. The enriched olein fraction is fractionated to extract StStSt (tri-stearate) and disaturated diglycerides StSt. The other glycerides are fractionated again to separate a StOSt rich fraction and a fraction rich in StOO and OOO. The latter fraction is bleached and purged before it is fed into the ETE process, while the first fraction is bleached to give a StOSt fraction.

According to an embodiment of the invention, the olein fraction is subjected to a refining and/or purification step. Such a step comprises a first neutralization to remove e.g. fatty acids, a second neutralization removing other acids, such as citric acid, and a bleaching step.

According to an embodiment of the invention, fractionation is used to separate a stream of fats into two fractions, e.g. a stearin fraction rich in StOSt and an olein fraction rich in StOO and OOO.

According to an embodiment of the invention, the outputs of the parallel process described in one or more aforementioned embodiments are a first cocoa butter equivalent (CBE1) and a second cocoa butter equivalent (CBE2).

According to an embodiment of the invention, the karitene is removed from the oil. This may be done in various suitable ways.

According to an embodiment of the invention, the oil is filtered in order to separate bleaching earth from the oil. The filtering process is a mechanical filtering process. In order to secure a sufficiently high filterability, the content of karitene must be low and/or the temperature must be high.

According to an embodiment of the invention, two parallel processes for production of cocoa butter equivalent (CBE) from shea butter are provided. Shea butter is fractionated into a stearin fraction rich in StOSt and an olein fraction rich in StOO and OOO. The olein fraction is used in an enzymatic transesterification process (ETE) to increase the content of StOSt. The StOSt is extracted to obtain a transesterified stearin fraction. The stearin fraction and the transesterified stearin fraction are used to make one or more CBEs.

The invention furthermore relates to a system comprising
a shea fat input (SFI)
a shea fat separator (SFS)
a first processing line (FPL)
a second processing line (SPL)
a first stearin output (FSO)
a second stearin output (SSO)
   and wherein the system is operated according to the process according to any of the above described embodiments.

The system as described above comprises a shea fat input, into which the shea fat may be fed. The shea fat separator is adapted to separate shea fat into a first and a second fraction, being e.g. a first shea stearin fraction and a shea intermediate product. The shea fat separator may e.g. comprise one or more fractionation step and/or one or more distillation steps. Also, the shea fat separator may comprise one or more refining and/or purification steps prior to or after the fractionation and/or distillation steps. The second processing line may preferably comprise an enzymatic transesterification process or alternatively other suitable processes, such as a chemical transesterification process, by means of which the shea intermediate product may be processed into a second shea stearin fraction.

The invention furthermore relates to a cocoa butter equivalent prepared from at least a processed shea fat prepared by a process according to any of the above described embodiments.

The invention furthermore relates to a chocolate confectionary product comprising a processed shea fat prepared by the process according to any of the above described embodiments.

By a chocolate confectionary product may be understood various products. Depending on the country and/or region there may be various restrictions on which products may be marketed as chocolate. By a chocolate confectionary product is meant a product, which at least is experienced by the consumer as chocolate, preferably being chocolate, or alternative as a confectionary product having sensorial attributes common with chocolate, such as e.g. melting profile, taste etc.

Though the cocoa butter equivalents produced by means of the invention may be advantageously used as a component in chocolate or chocolate-like products, it should be noted that the uses are versatile and includes use in bakery, frozen food-stuff, such as ice cream and a wide variety of other products.

### LIST OF REFERENCE NUMERALS

SF. Shea fat
SFI. Shea fat input
FPL. First processing line
SPL. Second processing line
SFS. Shea fat separator
FSS. First shea stearin fraction
SIP. Shea intermediate product
POMF. Palm oil mid fraction
SSS. Second shea stearin fraction
MIX1. First mixing process
MIX2. Second mixing process
CBEO1. First cocoa butter equivalent
CBEO2. Second cocoa butter equivalent
MIX. Mixing process
CBEO. Cocoa butter equivalent
ETP. Enzymatic transesterification process
FSO. First stearin output
SSO. Second stearin output
1. Shea nuts
2. Fractionation
3. Shea fat
4. First shea stearin fraction
5. First shea olein fraction
6. Stearic acid source
7. Enzymatic transesterification
8. Transesterified product
9. Shea stearin output
10. Mixing process
11. Palm oil mid fraction
12. Cocoa butter equivalent (CBE)
13. Fractionation process
14. Transesterified shea olein fraction
15. Second shea stearin fraction
16. Distilled transesterification product
17. Distillation
18. Hydrogenation process
19. Distilled fatty acid or alkyl esters thereof
20. Hydrogenated stearic alkyl esters
21. Removal of karitene
22. Karitene reduced shea fat

### FIGURES

The invention will be described in the following with reference to the figures in which

FIG. 1A illustrates a process and system for processing a shea fat,

FIG. 1B illustrates a process and system for processing a shea fat,

FIG. 2A illustrates a process and system for processing a shea fat,

FIG. 2B illustrates a process and system for processing a shea fat,

FIG. 3A illustrates a process and system for processing a shea fat,

FIG. 3B illustrates a process and system for processing a shea fat,

FIG. 4 illustrates a process and system for processing a shea fat,

FIG. 5 illustrates a process and system for processing a shea fat,

FIG. 6 illustrates a process and system for processing a shea fat, and

FIG. 7 illustrates a system for processing a shea fat.

### DETAILED DESCRIPTION

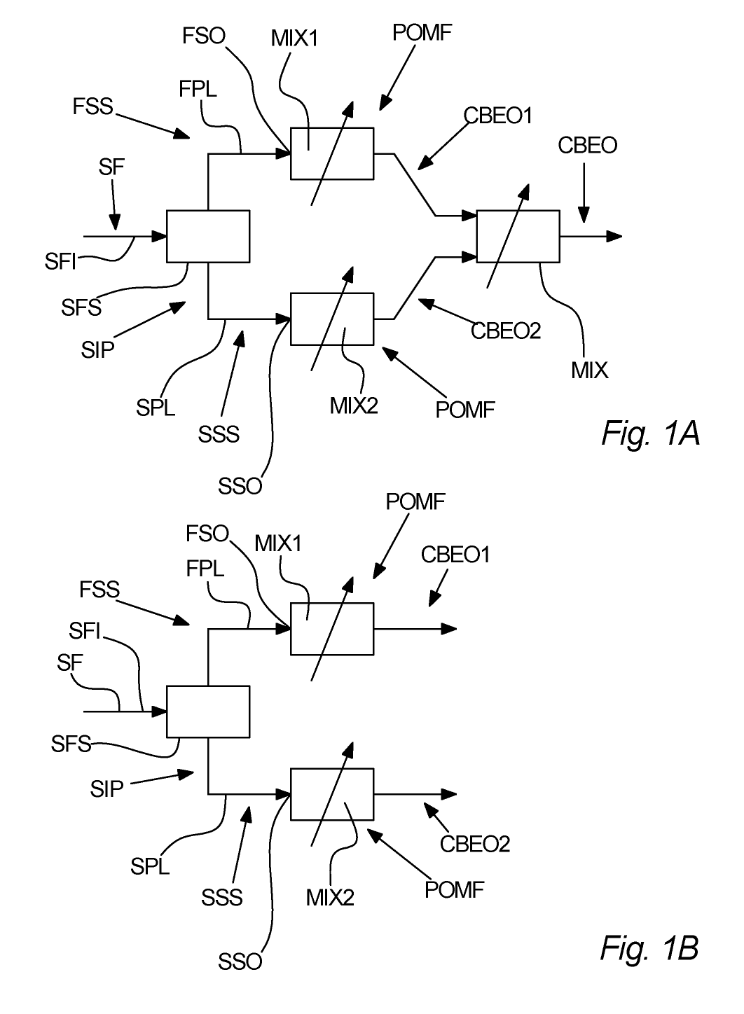

Referring to FIG. 1A, an embodiment of the invention is illustrated. According to the embodiment, a process for production of a cocoa butter equivalent output CBEO, i.e. of cocoa butter equivalent, comprises a number of steps. In the first step shea fat SF is provided into a shea fat input SFI. Then, the shea fat is separated into a first shea stearin fraction FSS and a shea intermediate product SIP by means of a separator SEP. The separator may be any type of unit or interacting units suitable for the purpose. According to a preferred embodiment of the invention, fractionation equipment is applied. The first shea stearin fraction FSS is fed into a first processing line FPL, while the shea intermediate product SIP is fed into a second processing line SPL. Then, the shea intermediate product SIP is processed in the second production line SPL into a second shea stearin fraction SSS. Thereafter, two separate shea stearin fractions or parts, FSS, SSS, are obtained; the first shea stearin fraction FSS from the first stearin output FSO of first processing line FPL and the second shea stearin fraction SSS from the second stearin output SSO of the second processing line SPL. Finally, the shea stearin fractions are mixed in a mixing process MIX with a palm oil mid fraction POMF to obtain a cocoa butter equivalent CBEO. The two shea stearin fractions or parts SSS, FSS a mixed individually in respective mixers, MIX1, MIX2 to obtain separate cocoa butter equivalent outputs CBEO1, CBEO2, which then may be mixed into a single cocoa butter equivalent output CBEO.

Again referring to FIG. 1A, an embodiment of the invention, hereunder a process for production of cocoa butter equivalent CBEO, is illustrated. First, a shea fat SF is provided to the process. Then, the shea fat SF is separated by a shea fat separator SFS into a first shea stearin fraction FSS and a shea intermediate product SIP. The first shea stearin fraction FSS is fed into a first processing line FPL. The first shea stearin fraction FSS is then obtained from the first processing line FPL and then mixed with a palm oil mid fraction POMF to obtain a first cocoa butter equivalent output CBEO1. The shea intermediate product SIP is processed in the second processing line SPL into a second shea stearin fraction SSS. The second shea stearin fraction SSS is then obtained from the second production line SPL, and then inputted to a mixing step MIX2 together with a palm oil mid fraction POMF to obtain a second cocoa butter equivalent output CBEO2. Finally, the cocoa butter equivalents CBEO1, CBEO2 are mixed into the cocoa butter equivalent CBEO. This cocoa butter equivalent CBEO may then have the characteristics of either the cocoa butter equivalents CBEO1, CBEO2, or a mixture of these characteristics. It is to be understood that the second shea stearin fraction SSS is a fraction or fat portion or fat being obtained based on a shea fat, hence reference shea. Even if fatty acids having another source than shea fat is used to obtain the second shea stearin fraction, this fraction may still be based on shea fat. Furthermore, by a fraction is meant a part or portion of the shea fat, which is processed in the second production line SPL, and being a second portion of fat being similar to the first shea stearin fraction and also being based on shea fat, and therefore referred to as a second shea stearin fraction SSS.

Referring to FIG. 1B, an embodiment of the invention is illustrated. A shea fat SF is separated by a shea fat separator SFS into a first shea stearin fraction SSS, which is fed into a first processing line SPL, and a shea intermediate product SIP, which is fed into a second processing line SPL. The first shea stearin fraction FSS is obtained from the first processing line FPL and used in a mixing MIX1 with a palm oil mid fraction POMF to obtain a first cocoa butter equivalent CBEO1. From the second processing line SPL is obtained a second shea stearin fraction SSS, which is mixed in a second mixing MIX2 with a palm oil mid fraction POMF to obtain a second cocoa butter equivalent CBEO2.

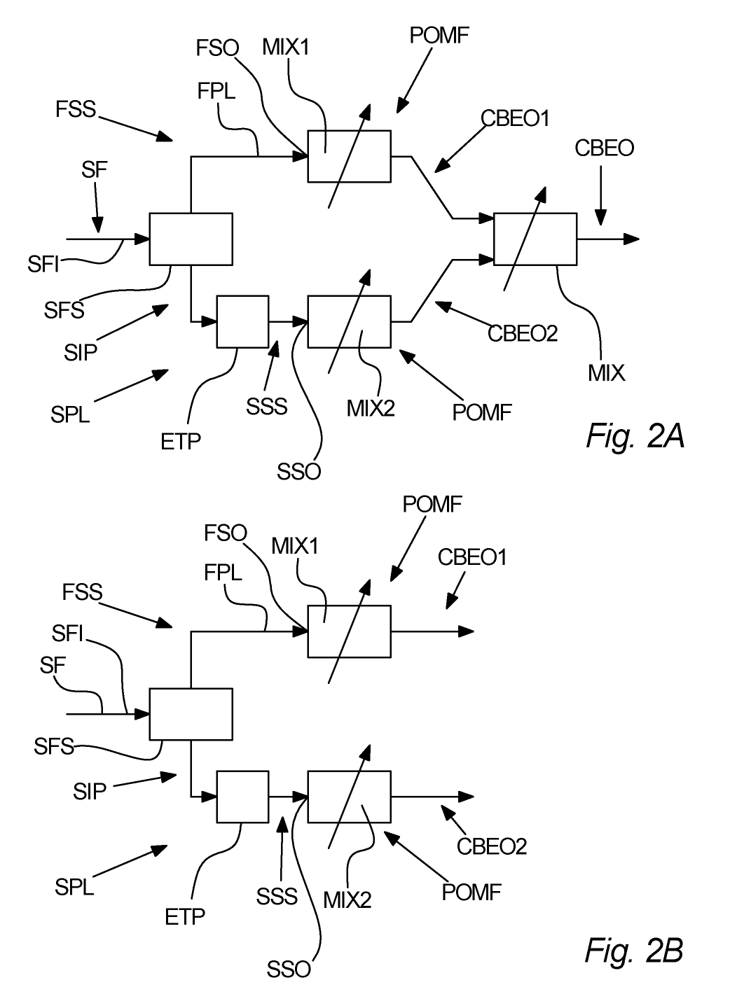

On FIG. 2A is illustrated a specific embodiment relating to the embodiment described with reference to FIG. 1A. According to the embodiment illustrated on FIG. 2A, a shea intermediate product SIP, which is obtained in a shea fat separator SFS, is fed through an enzymatic transesterification process ETP, which forms part of a second processing line SPL. Thereby, a second shea stearin fraction SSS is obtained on the basis of the shea intermediate product SIP. This second shea stearin fraction SSS may be mixed in a second mixing step MIX2 with a palm oil mid fraction POMF to obtain a second cocoa butter equivalent CBEO2, which may in turn be mixed with a first cocoa butter equivalent CBEO1 in a final mixing step MIX to obtain a final cocoa butter equivalent CBEO.

On FIG. 2B is illustrated a specific embodiment relating to the embodiment described with reference to FIG. 1B. According to the embodiment illustrated on FIG. 2B, a shea intermediate product SIP, which is obtained in a shea fat separator SFS, is fed through an enzymatic transesterification process ETP, which forms part of a second processing line SPL. Thereby, a second shea stearin fraction SSS is obtained on the basis of the shea intermediate product SIP. This second shea stearin fraction SSS may be mixed in a second mixing step MIX2 with a palm oil mid fraction POMF to obtain a second cocoa butter equivalent CBEO2. This second cocoa butter equivalent CBEO2 together with a first cocoa butter equivalent CBEO1 form the total output of cocoa butter equivalent obtained on the basis of shea fat from shea nuts.

An advantage of the processing of the above described embodiments, such as the embodiments illustrated on FIGS. 1A and 2A, is that the obtained cocoa butter equivalent CBEO may be adjusted from the properties of the natural content of the shea stearin contained in the shea nuts, i.e. from the properties of the first cocoa butter equivalent CBEO1, to the properties of the shea stearin produced on the basis of the shea intermediate product SIP extracted or derived from the same shea nut source, i.e. to the properties of the second cocoa butter equivalent CBEO2.

This is in particular an advantage if the second shea stearin fraction SSS is obtained by a very selective and precise production method, such as an enzymatic transesterification process ETP. In that case, it will be possible to obtain a natural output of shea stearin from the first processing line, i.e. the first shea stearin fraction FSS, and a pure shea stearin from the second processing line, i.e. the second shea stearin fraction SSS. These two types of shea stearin may thereafter be dealt with separately or together depending on the requirements to the final cocoa butter equivalent of shea stearin mixture. In other words, it will be possible to finalize the stearin parts FSS, SSS of the two processing lines FPL, SPL individually e.g. by the mixing of different amounts of palm oil mid fraction POMF into the two different shea stearin types FSS, SSS. It may also be possible to mix the same amount of palm oil mid fraction POMF into the two stearin types FSS, SSS, thereby maintaining the advantages of the two stearin types FSS, SSS. In this context, it is noted that the first shea stearin fraction FSS will have a natural variation in the triglyceride composition e.g. depending on which year the shea nuts have been harvested.

This variation may be less significant or absent in the second shea stearin fraction SSS due to the fact that the second shea stearin fraction SSS is obtained on the basis of a shea intermediate product SIP from a shea source, such as the shea fat SF. The variation in triglyceride composition of the second shea stearin fraction SSS may be very little in case the second shea stearin fraction SSS may be produced through a very selective process, e.g. by means of an enzymatic transesterification process ETP.

The first shea stearin FSS of the first processing line FPL may be produced by shea fat separation SFS, such as e.g. a fractioning process, meaning that the first stearin fraction FSS of the first production line FPL is shea stearin originating from and contained in the shea nut.

It is therefore possible to obtain a final cocoa butter equivalent CBEO mixture on the basis of any mixture of the first shea stearin fraction and the second shea fraction, the mixture including the application of only one of the two processing lines FPL, SPL, either the first shea stearin fraction FSS alone or the second shea stearin fraction SSS alone or any combinations thereof.

One of several advantages of the invention is that the stearin yield FSS, SSS obtained from shea nut input SF is very high due to the fact that the process adds further stearin than originally contained in the shea nut input SF due to the fact that some of the non-stearin content SIP of the shea nut is further processed into stearin content SSS in a separate processing line SPL.

The process may therefore be regarded as a very high-gain process and a high utilization of the shea nut input SF.

According to an embodiment of the invention, a shea stearin is to be understood as a higher melting point fraction or part of shea fat SF and/or as a fraction or part of shea fat SF, which is rich in StOSt triglycerides.

According to an advantageous embodiment of the invention, the two separate cocoa butter equivalent lines or processing lines FPL, SPL may be handled individually during or prior to the producing of the individual CBEO line. This means e.g. that the mixing of the palm oil mid fraction POMF with the provided shea stearin may be adapted to fit the shea stearin of the individual line. This is very beneficial for many reasons due to the fact that the shea stearin FSS naturally contained in the shea nut input and separated into the corresponding processing line FPL will have a different compositions and mix of triglycerides than the shea stearin provided on the basis of the shea intermediate product SIP of the other processing line SPL. Furthermore, due to regional and/or national law, the output of the second processing line SPL may or may not be partly or completely restricted from being in products marketed as chocolate. Thereby, it may in some embodiments be advantageous to keep the outputs of the first and second processing lines FPL, SPL separate.

In fact, experiments have shown that this different content of triglycerides will result in different properties of chocolate produced on the basis of the produced cocoa butter equivalent CBEO. According to the provisions of the above embodiment, it is therefore possible to make an individual mixture of the two processing lines FPL and SPL and either adjust the two outputs FSS and SSS individually to obtain the desired properties of each line or mix the stearin parts or outputs FSS, SSS into a single output line with the palm oil mid fraction POMF to obtain one common property of the cocoa butter equivalent output CBEO.

Moreover, it will be possible to maintain the two outputs FSS, SSS and thereby take advantage of the different properties of the two processing lines FPL and SPL.

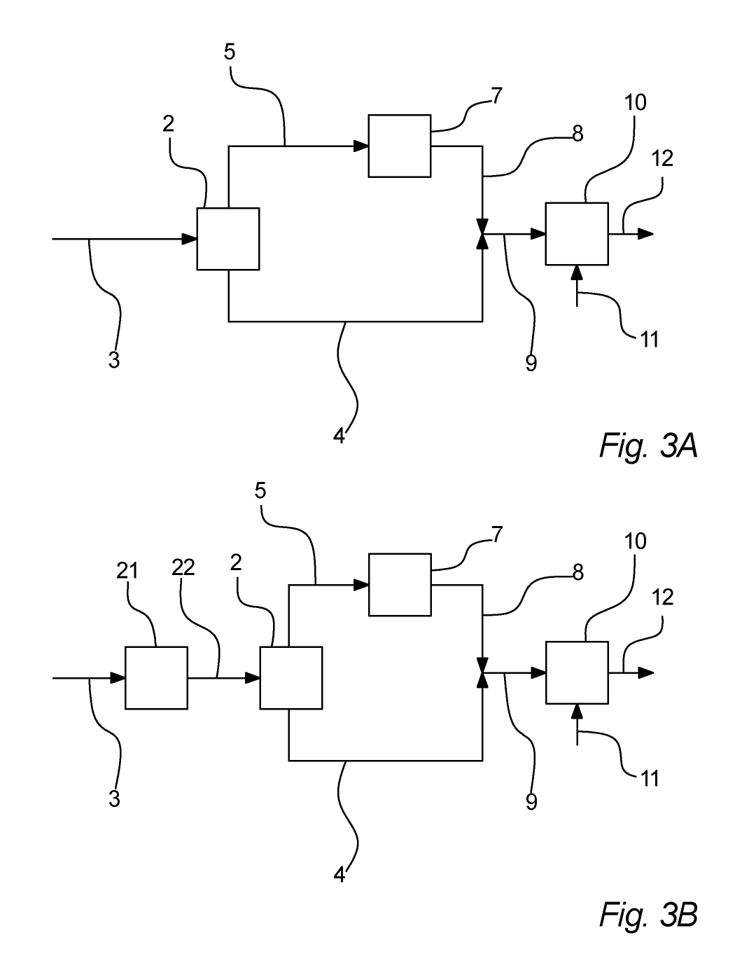

Referring to FIG. 3A, a process for utilization of shea fat according to an embodiment of the invention is illustrated. A shea fat 3 extracted from shea nuts 1 is first subjected to a fractionation process 2. In this fractionation process 2, a solvent may optionally be added to the shea fat 3, and removed after separation into fractions. Also, the temperature of the shea fat 3 with optional solvent may optionally be adjusted. Thereby, the components with the lowest solubility may be made to precipitate. The precipitating components may then be extracted by liquid-solid separation as a first shea stearin fraction 4, while the remaining liquid may be extracted as a first shea olein fraction 5. Optionally added solvents may be removed from the first shea stearin fraction 4 and the first shea olein fraction 5 to obtain purer fractions. The high melting point components of the shea fat 3 in the first shea stearin fraction 4 comprise symmetrically disaturated triglycerides; more specifically 1,3-distearyl-2-oleyl-triglyceride, from here on StOSt (St=stearic acid, O=oleic acid). The lower melting point components of the shea fat in the second fraction 5 comprise the asymmetric monosaturated triglyceride StOO and the tri-unsaturated triglyceride OOO. The first shea stearin fraction 4 has a high content of the valuable StOSt, such as a content of approximately 66% by weight of StOSt. The first shea olein fraction 5 has a low content of valuable triglycerides, and is instead rich in StOO and OOO, which are of considerably lower value compared to StOSt. Therefore, only a part of the triglycerides from the shea fat 3, namely the first shea stearin fraction 4, is of substantial value. However, by using a process for enriching the first shea olein fraction 5, it has been possible to increase the yield of valuable fat from the shea fat 3 significantly. This enrichment is illustrated on FIG. 3A as an enzymatic transesterification process 7, where StOO and/or OOO triglycerides are converted into StOSt triglycerides. The output of the transesterification process 7 is a transesterified product 8 with an increased, preferably significantly increased, content of StOSt triglycerides. Both the first fraction 4 and the transesterified product 8 and/or a fraction thereof may be mixed with a palm oil mid fraction 11 as illustrated on FIG. 3A to obtain a valuable cocoa butter equivalent 12. This may e.g. be as illustrated on FIG. 3A, where the transesterified product 8 and the first fraction 4 are mixed together or joined to obtain a joint shea stearin output 9 before being mixed with the palm oil mid fraction 11 to obtain a cocoa butter equivalent 12. Alternative, the first fraction 4 and the transesterified product 8 are inputted separately to the mixing step 10. By means of the illustrated method, the potential for cocoa butter equivalent product 12 using shea fat 3 is increased substantially.

On FIG. 3B is illustrated an embodiment of the invention in which a step of removal of karitene 21 is performed before the step of fractionation 2. In alternative embodiments, a step 21 of removal of karitene may be involved after the step of fractionation 2, i.e. on the lower melting point fraction 5 and the higher melting point fraction 4. The removal of karitene 21 may be carried out in various suitable ways.

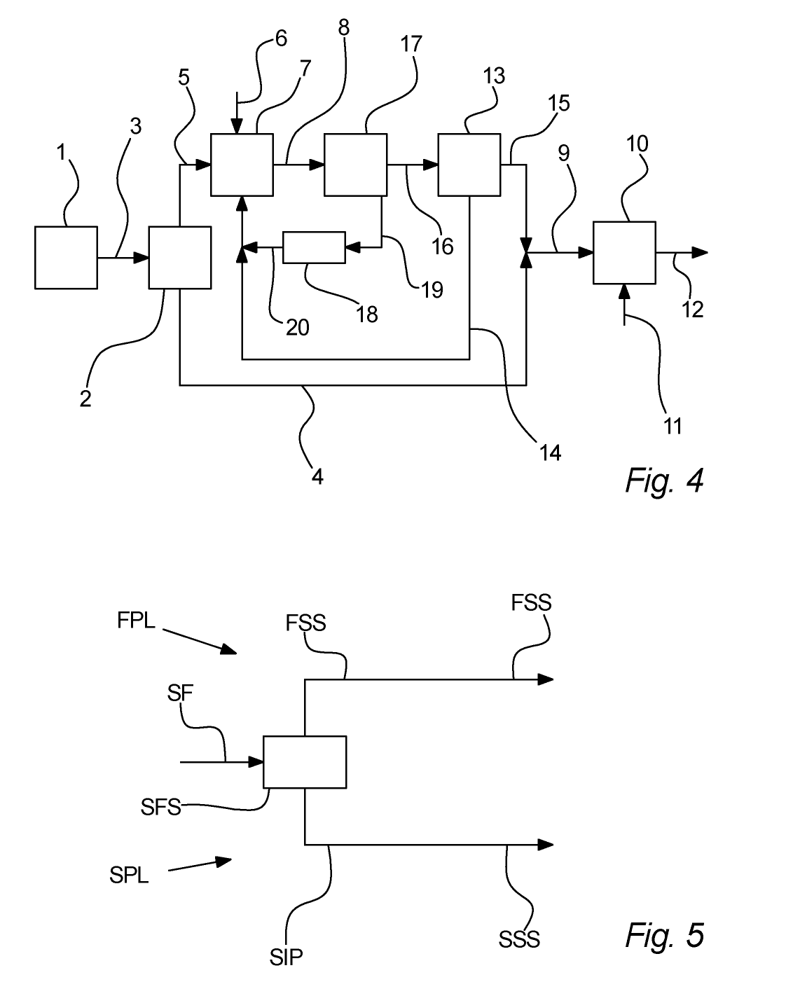

Now, referring to FIG. 4, a process for production of cocoa butter equivalent CBEO is illustrated. The shea fat 3 extracted from shea nuts 1 is fed into a fractionation process 2. It is to be understood that the shea fat 3 is based on extracted fat from shea nuts 1, i.e. some additives may be present, and the shea fat 3 may be refined, e.g. by using solvents etc. The shea fat 3 is fractionated in the fractionation step 2 into a lower melting point fraction or first shea olein fraction 5 and a higher melting point fraction or first shea stearin fraction 4. The lower melting point fraction 5 is fed into a transesterification step 7 together with a stearic acid source 6, comprising e.g. a fatty acid alkyl ester of stearic acid, such as a stearic acid alkyl ester, such as stearic acid lower alkyl ester, such as methyl stearate, ethyl stearate, or stearic acid, or another source of stearic acid, such as stearic acid in the form of free fatty acids. Here it should be noted that the stearic acid source 6, such as methyl stearate, is not chemically 100% pure; e.g. such stearic acid source 6 may in an example embodiment contain up to e.g. 10% by weight of palmitic acid and/or other fatty acids, such as 6-10% of palmitic acid, This palmitic acid or other fatty acids may be free fatty acids or esters thereof. Also, the stearic acid source may comprise free fatty acids, such as e.g. stearic, oleic or palmitic acid, in the form of free fatty acids. The amount of these free fatty acids in the stearic acid source may in an example embodiments be up to e.g. 5% by weight. In general, the stearic source comprises stearic acid as a free fatty acid or an ester thereof, such as e.g. methyl stearate, in amounts that facilitate a satisfactory conversion of triglycerides into StOSt. The stearic acid content of the stearic acid source may therefore by at least 70% by weight, such as at least 80% by weight, such as at least 90% by weight, such as at least 95% by weight. The transesterification product 8 is distilled in a distillation step 17 in which distilled fatty acid or alkyl esters thereof 19 are separated from the distilled transesterification product 16. The distilled fatty acid or alkyl esters thereof 19 typically comprise oleic acid and stearic acid and/or esters thereof. The distilled fatty acid or alkyl esters thereof 19 are fed through a hydrogenation process 18 to hydrogenate double bonds on the fatty acids or esters thereof, therefore mainly converting the oleic acid or esters thereof into corresponding stearic acid or esters thereof, giving hydrogenated stearic acid alkyl esters 20. The distilled transesterification product 16 is fractionated in fractionation step 13 to produce a transesterified shea stearin fraction 15 and a transesterified shea olein fraction 14. The transesterified shea olein fraction 14 and the hydrogenated stearic acid alkyl esters 20 are fed back into the enzymatic transesterification 7. In theory, it is thereby possible to eliminate the need for an external stearic acid source 6. However, depending on the efficiency of the handling of stearic and oleic acids and/or their corresponding esters, it may be possible to reduce the need for external stearic acid source 6 significantly. The transesterified shea stearin 15 and the shea stearin fraction 4 may then be mixed with a palm oil mid fraction POMF, 11 in a mixing step 10 to produce a cocoa butter equivalent CBEO, 12. According to various embodiments, the two shea stearin fractions or parts, i.e. the shea stearin fraction 4 and the transesterified shea stearin 15 may be mixed together before being fed into the mixing step 10, or they may be kept separated to form two distinct cocoa butter equivalent products, which may or may not be mixed to give a resulting mixed cocoa butter equivalent or maintained as a natural cocoa butter equivalent and a pure and chemically well-defined cocoa butter equivalent.

Now, on FIG. 5 another embodiment of the invention is illustrated. The shea fat SF is separated into a first shea stearin fraction FSS and a shea intermediate product SIP by the shea fat separator SFS, The first shea stearin fraction FSS is fed into a first processing line FPL, while the shea intermediate product SIP is fed into a second processing line SPL. From the two processing lines is obtained a first and a second shea stearin fraction FSS, SSS, which may be used separately or mixed together to obtain a new shea stearin fraction having any combination or mixture of the characteristics of the two shea stearin fractions; from the natural first shea stearin fraction to the pure and/or chemically well-defined second shea stearin fraction. One or two of the stearin outputs, or a mixture may then be used to produce one or more cocoa butter equivalents.

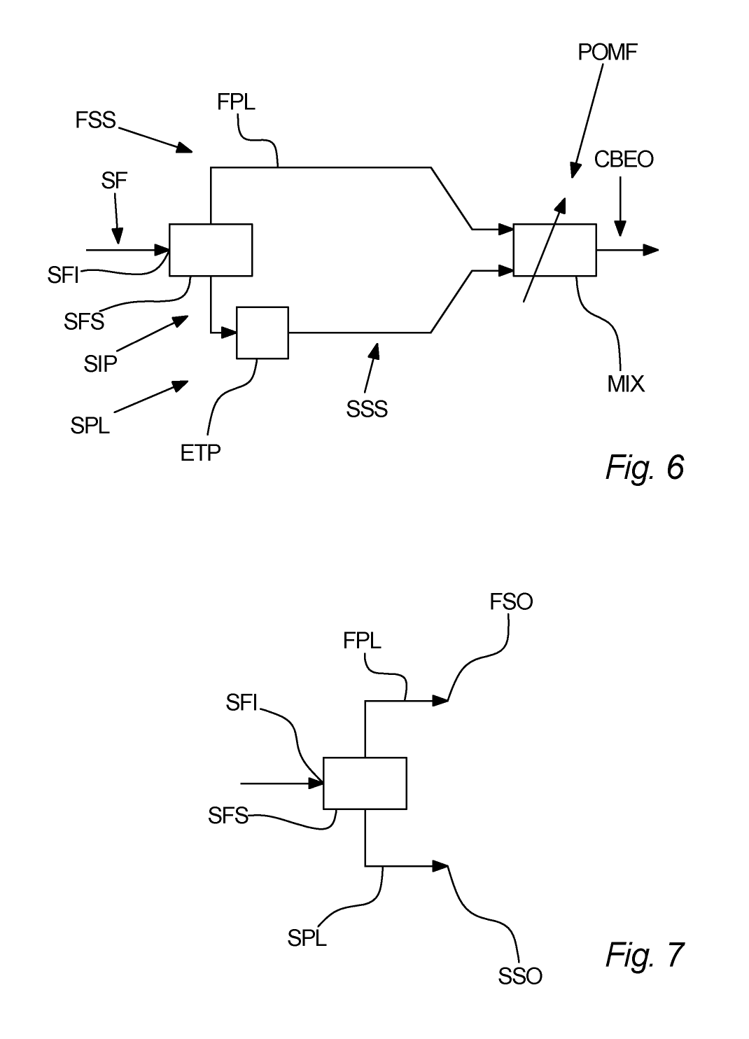

On FIG. 6 another embodiment of the invention is illustrated. Further to previously described embodiments, the embodiment of FIG. 6 illustrates that the first shea stearin fraction FSS and the second shea stearin fraction SSS produced e.g. in the enzymatic transesterification process ETP may be mixed together or joint in a mixing step MIX with a palm oil mid fraction POMF to produce a cocoa butter equivalent. By adjusting the mixing of the first shea stearin fraction FSS, the second shea stearin fraction SSS, and the palm oil mid fraction POMF, it is possible to obtain a cocoa butter equivalent CBEO, which has characteristics based on the first shea stearin fraction FSS, or the second shea stearin fraction SSS, or anywhere in-between.

On FIG. 7, another embodiment of the invention is illustrated. According to this embodiment, a system for processing of shea fat SF is provided. The shea fat SF is inputted through a shea fat input SFI. Then the shea fat SF is separated by a shea fat separator SFS, which may comprise one or more fractionations and/or distillations, into a first shea stearin fraction FSS and a shea intermediate product SIP. The first shea stearin fraction FSS is fed through a first processing line FPL and may be obtained again from a first stearin output FSO. The shea intermediate product SIP is fed through a second processing line SPL, in which the shea intermediate product SIP is processed into a second shea stearin fraction SSS. This second shea stearin fraction SSS may be obtained from a second stearin output SSO. The second processing line SPL may preferably comprise a unit or suitable equipment for performing an enzymatic transesterification process ETP.

### Example 1

Using 100 kg of refined shea fat, 49 kg of StOSt component for cocoa butter equivalent is produced by conventional fractionation. The StOSt content of the StOSt component is approximately 66% by weight. From the 49 kg of StOSt component, a cocoa butter equivalent was produced by mixing 46 parts of StOSt component with 54 parts of palm oil mid fraction. This gave approximately 106 kg of CBE.

### Example 2

By using the method according to the invention, 80 kg of stea stearin output usable as StOSt component for cocoa butter equivalent has been produced from 100 kg refined shea fat, i.e. an additional 31 kg of StOSt component compared to the result in example 1. The 80 kg shea stearin output has been mixed with palm oil mid fraction, the mixing output containing approximately 45% by weight of shea stearin output and 55% by weight of palm oil mid fraction. This mixing gave approximately 174 kg of cocoa butter equivalent.

1. A process for production of cocoa butter equivalent (CBEO), wherein the process comprising the steps of:
providing shea fat (SF);
separating the shea fat into a first shea stearin fraction (FSS) and a shea intermediate product (SIP);
feeding the first shea stearin fraction (FSS) into a first processing line (FPL);
feeding the shea intermediate product (SIP) into a second processing line (SPL);
processing the shea intermediate product (SIP) in the second production line (SPL) into a second shea stearin fraction (SSS);
obtaining two separate shea stearin outputs, the first shea stearin fraction (FSS) from the first processing line (FPL) and the second shea stearin fraction (SSS) from the second processing line (SPL); and
mixing the shea stearin outputs from the FPL and SPL (FSS, SSS) with a palm oil mid fraction (POMF) (process of mixing referred to as MIX) to obtain cocoa butter equivalent (CBEO).

2. The process according to claim 1, wherein
the shea stearin output comprising the first shea stearin fraction (FSS) and the second shea stearin fraction (SSS) is individually mixed with palm oil mid fraction (POMF) (first mixing process as MIX1, second mixing process as MIX2) to obtain two separate cocoa butter equivalent (CBEO1, CBEO2) outputs.

3. The process according to claim 1, wherein the outputs of the two processing lines (FPL, SPL) are individually mixed with palm oil mid fraction (POMF) (process of each individual mixing referred to as MIX1, MIX2).

4. The process according to claim 1, wherein the outputs of the two processing lines (FPL, SPL) are mixed with palm oil mid fraction (POMF) in a common mixing process.

5. The process according to claim 1, wherein the process comprises the steps of:
a) separating the shea fat (3, SF) into a first shea stearin fraction (4, FSS) rich in 1,3-distearyl-2-oleyl triglycerides (StOSt, where St=stearic acid and O=oleic acid) and a first shea olein fraction (5, SIP) rich in 1-stearyl-2,3-dioleyl triglycerides (StOO) or trioleate triglycerides (OOO) or the combination thereof;
b) feeding a shea olein fraction comprising the first shea olein fraction (5, SIP), together with a stearic acid source (6), into a reaction system comprising immobilized enzymes having transesterification activity to produce a transesterification product (8);
c) separating the transesterification product (8) from a second shea stearin fraction (15) rich in StOSt,
thereby producing a shea stearin output (9) comprising the first shea stearin fraction (4, FSS) in a first processing line (FPL) and the second shea stearin fraction (15, SSS) in a second processing line (SPL).

6. The process according to claim 5, wherein the first shea stearin fraction (4, FSS) comprises between 30 and 100 percent by weight of StOSt.

7. The process according to claim 5, wherein the first shea olein fraction (5, SIP) comprises between 30 and 70 percent by weight of StOO.

8. The process according to claim 5, wherein the first shea olein fraction (5, SIP) comprises between 1 and 20 percent by weight of OOO.

9. The process according to claim 1, wherein the temperature in the reaction system is between 45 and 75° C.

10. The process according to claim 5, wherein the water content of the first three olein fraction (5, SIP) is between 0.01 and 0.5 percent by weight when it is fed into the reaction system.

11. The process according to claim 5, wherein the stearic acid source (6) is stearic acid.

12. The process according to claim 5, wherein the stearic acid source (6) is an ester of stearic acid.

13-14. (canceled)

15. The process according to claim 5, wherein the transesterification product (8) is separated into at least a second shea olein fraction (14) and the second shea stearin fraction (15) by a fractionation process (13).

16. The process according to claim 15, wherein the fractionation process (13) is a solvent fractionation process comprising the steps of:
adding a solvent to the transesterification product (8);
adjusting the temperature according to a temperature profile;
separating from the transesterification product (8) the second shea stearin fraction (15) and the second shea olein fraction (14).

17-19. (canceled)

20. The process according to claim 15, wherein the second shea olein fraction (14) is recycled as the shea olein fraction together with the stearic acid source (6), into the reaction system comprising immobilized enzymes having transesterification activity to produce the transesterification product (8).

21. The process according to claim 5, wherein a fatty acid ester mixture (19) comprising esters of stearic, oleic acid, or the combination thereof, are being separated from the transesterification product (8), wherein the separated fatty acid ester mixture (19) is subjected to a hydrogenation step (18) to increase the relative content of esters of stearic acid, and wherein the hydrogenated esters (20) are recycled as the shea olein fraction together with the stearic acid source (6), into a reaction system comprising immobilized enzymes having transesterification activity to produce the transesterification product (8).

22-28. (canceled)

29. The process according to claim 5, wherein the ratio between the stearic acid and oleic acid in the shea stearin output (9) is between 2:3 and 2:1.

30-33. (canceled)

34. The process according to claim 5, wherein a subsequent step of mixing the shea stearin output (9) with a palm oil mid fraction (11, POMF) is performed to obtain a cocoa butter equivalent (12, CBEO).

35-38. (canceled)

41. The process according to claim 5, wherein the process for efficient utilization of shea fat (3, SF) comprises a step (21) of removing karitene from the shea fat (3, SF) before the step of separating the shea fat (3, F) into the first shea stearin fraction (4, FSS) and the first shea olin fraction (5, SIP), wherein the concentration of karitene in the shea fat (3, SF) after the step of removing karitene is less than 0.6 percent by weight.

42-46. (canceled)

47. The process for making cocoa butter equivalent (CBEO) from the shea stearin output (9) obtained by a process according to claim 5 and a palm oil mid fraction (POMF), wherein between 1.2 and 2 kilograms of cocoa butter equivalent (CBEO) is produced for each kilogram of the shea fat (3, SF).

48. A System comprising:
a shea fat input (SFI);
a shea fat separator (SFS);
a first processing line (FPL);
a second processing line (SPL);
a first stearin output (FSO);
a second stearin output (SSO);
wherein the system is operated according to the process of claim 1.

49. A cocoa butter equivalent (CBEO) prepared from at least a processed shea fat (3, SF) prepared by a process according to claim 1.

50. A chocolate confectionary product comprising a processed shea fat (3, SF) prepared by the process according to claim 1.
